(19) United States
(12) Patent Application Publication
(10) Pub. No.: US 2024/0041073 A1
(43) Pub. Date: Feb. 8, 2024

(54) METHOD FOR MANUFACTURING PROCESSED FOOD

(71) Applicant: JUNG JU MUN, Seongnam-si (KR)

(72) Inventor: JUNG JU MUN, Seongnam-si (KR)

(21) Appl. No.: 17/881,625

(22) Filed: Aug. 5, 2022

(51) Int. Cl. A23L 3/10; A23L 3/16; A23L 3/015; A23L 3/365; A23B 4/005; A23B 4/07; A23B 7/005; B65D 65/40

(52) U.S. Cl. CPC A23L 3/10; A23L 3/16; A23L 3/015; A23L 3/365; A23B 4/005; A23B 4/07; A23B 7/005; B65D 65/40; A23V 2002/00

(57) ABSTRACT

A method for manufacturing a processed food is provided, which includes steps of (a) processing raw materials classified per characteristics into a food, (b) after the step (a), weighing aged processed food by a predetermined weight, and inner packaging the weighed processed food with a laminated transparent film in which a polypropylene film, nylon and CPR are laminated together; (c) after the step (b), sterilizing the processed food at a low temperature and at high a temperature and a high pressure, and cooling the sterilized processed food at a predetermined temperature or lower, and (d) after the step (c), performing a detection test for metallic components in the sterilized and cooled processed food and then outer packaging the same.

### TECHNICAL FIELD

The present disclosure relates to a method for manufacturing a processed food, and more specifically, to a method for manufacturing a processed food, in which pathogenic microorganisms such as bacteria, coliform group, or salmonella is suppressed, and the food can be distributed and stored at room temperature so that it can be used as a meal replacement or snack for various domestic and foreign consumer groups such as picnic gatherings, hikers, dieters, health trainers, and so on to satisfy consumer needs, and also can be stored at a room temperature for a long period of time and thus exportable by sea so that the cost of distribution by exporting can be reduced.

### BACKGROUND

In the very complicated and diverse daily life, modern people easily use processed foods everywhere for a meal replacement, and in particular, they demand a variety of products including natural additive-free products or processed products evenly combining nutritious foods, and various foods and livestock processed foods are being launched especially for weight loss.

In general, meat/fish such as chicken breast, beef and the like is widely used as processed food for weight loss, but for the meat/fish, even if it is stored at cold temperature, there may be a problem of propagation of microorganisms in the food which can harm human health if it is left unconsumed for more than about 8 days after slaughter.

In order to address this problem, processed food manufacturers develop various products to solve the problem, and adopt various storage methods to maintain the quality for a long period of time.

One of the widely used methods is the storage method that uses temperature, which includes cooling storage or freeze storage, but the cooling storage method mentioned above is only possible for a short period time between 3 days and 3 months in a separate storage place with refrigeration facility, and if failing to maintain complete temperature control, it is highly possible that microorganisms propagate even within that time period or consumer complaint may occur due to changed sensory feels.

In addition, for the freeze storage and distribution method, space is limited and considerable cost is incurred during storage, defrosting is inconvenient, and tissue damage and taste change of products due to freezing and defrosting occur.

For another method of long-term storage, there is a storage method that utilizes packaging methods. Use of cans or canned foods is the representative example, and products using this packaging method are stored for a long period of time of almost 3 years, but reliability of such product can be questioned as it is not possible to check the inside of the products.

### SUMMARY

In order to solve the problem discussed above, the present disclosure has been made in consideration of the related art mentioned above, and accordingly, the present disclosure relates to a method for manufacturing a processed food, in which pathogenic microorganisms such as bacteria, coliform group, or salmonella are suppressed, and the food can be distributed and stored at room temperature so that it can be used as a meal replacement or snack for various domestic and foreign consumer groups such as picnic gatherings, hikers, dieters, health trainers, and so on.

Further, the present disclosure relates to a method for manufacturing a processed food, in which the food can be stored at a room temperature for a long period of time and thus can be exportable by sea, so that the cost of distribution by exporting can be reduced.

Further, the present disclosure relates to a method for manufacturing a processed food which performs packaging using a thin special polypropylene film to provide portability and convenience and also maintains moisture of processed food for a long period of time.

It should be understood, however, that the scope of the present disclosure is not limited to the above and that the objects and effects which can be understood from the solution means and the embodiments of the present disclosure are also included therein even if not explicitly mentioned.

According to an embodiment of the present disclosure for achieving the above object, the disclosure may include steps of (a) processing raw materials classified per characteristics into a food, (b) after the step (a), weighing aged processed food by a predetermined weight, and inner packaging the weighed processed food with a laminated transparent film in which a polypropylene film, nylon and CPR are laminated together; (c) after the step (b), sterilizing the processed food at a low temperature and at high a temperature and a high pressure, and cooling the sterilized processed food at a predetermined temperature or lower, and (d) after the step (c), performing a detection test for metallic components in the sterilized and cooled processed food and then outer packaging the same.

According to an embodiment of the present disclosure, the step (a) may include, when the raw material has a characteristic of an agricultural product including grains, including vegetables, sweet potatoes, sweet pumpkin, and potatoes, an egg produced from poultry, and a fish including mackerel, Japanese Spanish mackerel, and Atka mackerel, washing the raw material, selecting the washed raw material according to its state, and removing a non-edible part of the selected raw material.

According to an embodiment of the present disclosure, the step (a) may include a curing step of mixing and curing the raw material and auxiliary material, when the raw material has a characteristic of meat or poultry that can be prepared as ham, ground processed meat, and sausage, or fish that can be cooked as grilled shrimp or grilled eel, after the curing, a heating step of heat-treating the cured processed food, and after the heating, a step of naturally cooling the processed food at room temperature, and when the natural cooling is finished, aging by cold storage.

According to an embodiment of the present disclosure, the disclosure may include, when the raw material and the auxiliary material are mixed, putting 90 to 97% by weight of raw materials, and 1 to 4.5% by weight of chicken concentrate, 1 to 2.5% by weight of barbecue seasoning, 0.5 to 1.0% by weight of seaweed and 0.5 to 2.0% by weight of the additives into the vacuum tumbler for mixing, in which the chicken concentrate may include a mixture of 94.56% by weight of chicken extract, 2.54% by weight of cyclodextrin, 1.52% by weight of vegetable extract containing onion, garlic, red pepper, and green onion, and 1.38% by weight of fruit extract containing pear, grapefruit and apple.

According to an embodiment of the present disclosure, the curing may include (a1) when the raw material is meat or poultry, a first curing step of putting the raw material and the auxiliary material into vacuum tumbler, and mixing while maintaining a vacuum degree of −0.08 to −0.1 cmHg for 20 to 30 minutes, and (a2) after the step (a1), a second curing of adding polyphosphate to the raw material and mixing while maintaining a vacuum degree of −0.08 to −0.1 cmHg for 20 to 30 minutes.

According to an embodiment of the present disclosure, the heating step may include, when the raw material is meat or poultry, heat treating the first processed food at a temperature of 70 to 90° C. in a heat chamber for 30 to 50 minutes, and when the raw material is fish, heat treating in an oven machine at a temperature of 180 to 250° C. for 3 to 10 minutes.

According to an embodiment of the present disclosure, the step (c) may include bulk packaging in a vinyl based on a unit of 7-8 kg or less, wherein the packaging is performed with a semi-vacuum packaging method for 13 to 18 seconds at a pressure of 0.09±0.005 MPa, and then aging at a temperature of −2° C. to 5° C.

According to an embodiment of the present disclosure, the step (b) may include sealing the laminated transparent film according to conditions including a vacuum time of 14 to 20 seconds, a sealing adhesion time of 3 to 5 seconds, a sealing temperature of 150° C. to 180° C., to achieve a vacuum degree of 0.085 to 0.1 MPa.

According to an embodiment of the present disclosure, the step (c) may include first sterilizing the processed food at 55° C. to 75° C. for 30 to 40 minutes, second sterilizing at 90° C. to 110° C. for 30 to 50 minutes, third sterilizing by heating at 110° C. to 140° C. for 20 to 50 minutes, and after completing the third sterilizing, performing cooling at 40° C. or lower.

According to an embodiment of the present disclosure, the laminated transparent film may include the polypropylene film, nylon and CPR laminated together.

According to an embodiment of the present disclosure, the laminated transparent film may be formed so that one side is transparent to allow the processed food to be seen therethrough, or the entire surface may be formed to be opaque.

Advantageous effects are provided according to the embodiments of the present disclosure. That is, pathogenic microorganisms such as bacteria, coliform group, or salmonella are suppressed, and it is possible to satisfy consumer needs since distribution and storage at room temperature is possible, thus enabling use as a meal replacement or snack for various domestic and foreign consumer groups such as picnic gatherings, hikers, dieters, health trainers, and so on.

Further, according to the embodiments of the present disclosure, the processed food can be stored at a room temperature for a long period of time and thus exportable by sea so that the cost of distribution by exporting can be reduced.

Further, according to an embodiment of the present disclosure, by performing packaging using a thin special polypropylene film, the state of the processed food can be visually checked, and portability and convenience are also provided, and feeling of moisture in the processed food can be kept for a long period of time, and as a result, the reliability of processed foods can be enhanced.

Further, the various and beneficial advantages and effects of the present disclosure are not limited to the above description, and can be more easily understood in the course of describing a specific embodiment of the present disclosure.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a schematic flowchart of a method for manufacturing a processed food according to an embodiment of the present disclosure;

FIG. 2 is a table listing the results of sensory evaluation on degrees of rancidity according to vacuum degrees of the processed food manufactured by the method for manufacturing a processed food according to an embodiment of the present disclosure; and

FIGS. 3 and 4 are exemplary views illustrating a laminated transparent film for inner packaging, with which inner packaging of meat/fish processed food is to be performed according to an embodiment of the present disclosure.

### DETAILED DESCRIPTION

Hereinafter, preferred embodiments of the present disclosure will be described in detail with reference to the accompanying drawings. It should be noted that, when adding reference numerals to the components shown in the drawings, the same components, whether they are illustrated in the same drawing or different drawings, will be denoted by the same reference numerals. In the following description of the present disclosure, a detailed description of known functions and configurations incorporated herein will be omitted when it may make the subject matter of the present disclosure rather unclear.

Further, while describing the components of the present disclosure, “first,” “second,” “A,” “B,” “(a),” “(b)” and so on may be used. However, these are used solely for the purpose of distinguishing one component from another, and do not limit the nature, sequence or order of the corresponding components. When a certain component is stated as being “connected” or “coupled” to another component, it is to be understood that there may be yet another intervening component “connected” or “coupled between the two components, although the two components may also be directly connected or coupled to each other.

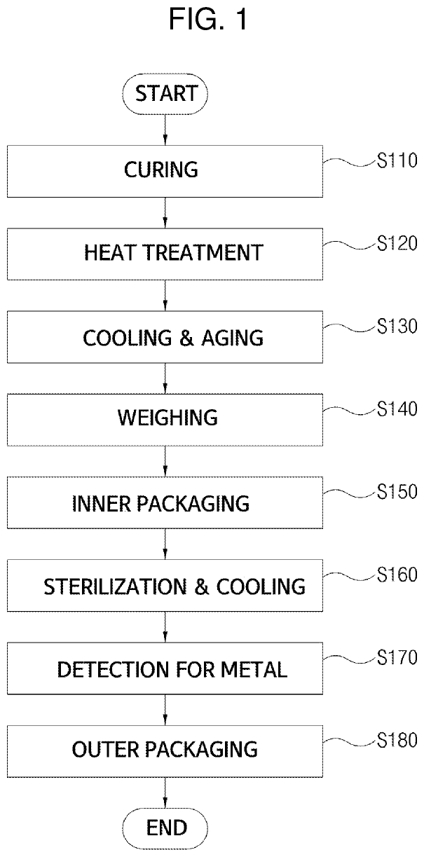

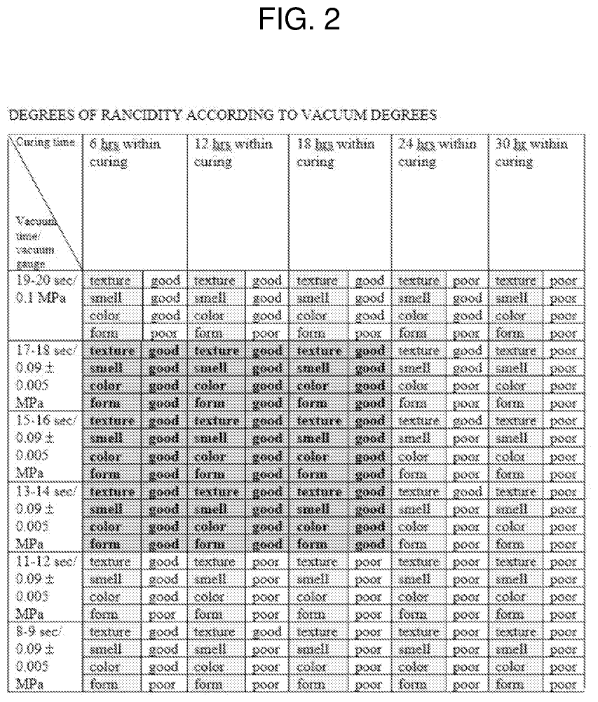

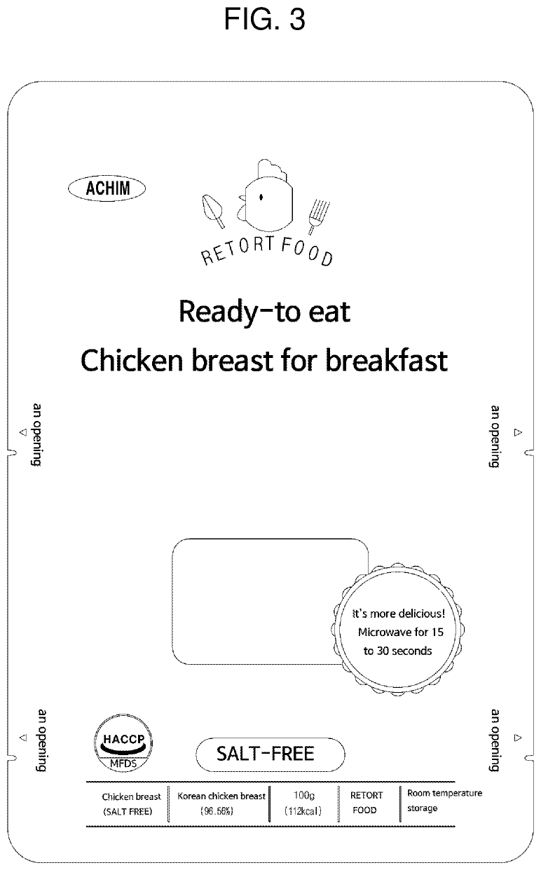

FIG. 1 is a schematic flowchart of a method for manufacturing a processed food according to an embodiment of the present disclosure, FIG. 2 is a table listing the results of sensory evaluation on degrees of rancidity according to vacuum degrees of the processed food manufactured by the method for manufacturing a processed food according to an embodiment of the present disclosure, and FIG. 3 is an exemplary view illustrating a laminated transparent film for inner packaging, with which inner packaging of meat/fish processed food is to be performed according to an embodiment of the present disclosure.

According to the present disclosure, the method includes a preparation step of processing a food by mixing and curing raw materials and auxiliary materials, inner packaging the food processed at the preparation step, sterilizing a product finished with the inner packaging, and a storing and delivering step of inspecting for the presence of metal and shipping.

In one example, the raw materials include raw meat such as meat such as beef, pork, and the like, poultry such as chickens, ducks, and the like, and fish such as shrimp, eel, mackerel, Japanese Spanish mackerel, Atka mackerel, and the like, eggs from poultry, quail eggs, and the like, and agricultural products including grains, such as various vegetables, sweet potatoes, sweet pumpkins, potatoes, and the like.

In addition, depending on their characteristics, the raw materials may be differently applied, that is, the raw materials may be processed as they are or may be mixed and processed together with auxiliary materials.

In one example, the raw materials that are mixed and processed with the auxiliary materials may include meat or poultry that can be manufactured as hams, ground processed meats, sausages, etc., or fish such as shrimps or eels that can be cooked by grilling, and the like, and the raw materials that are processed as they are may include agricultural products including vegetables and grains, eggs, or fish such as mackerel, Japanese Spanish mackerel, Atka mackerel and the like.

In one example, when performing the preparation step, when the raw materials used are to be processed as they are, rather than going through the steps of curing, sterilizing, cooling, and aging which will be described below, the raw materials may go through the steps of, in order, washing the raw materials, selecting the washed raw materials according to their states, and removing a non-edible part from the selected raw materials.

In other words, according to the present disclosure, the raw materials may be classified according to their characteristics, and the raw materials classified according to their characteristics may be processed in different manners respectively to be manufactured into a food.

Further, the preparation step includes, in order: a curing step S110 of putting, among the raw materials, a raw material to be mixed and processed with auxiliary materials, together with an auxiliary material to be mixed with the raw material into a vacuum tumbler, and mixing the materials under a predetermined pressure for a predetermined period of time; a heating step S120 of heating a first processed food, which is processed at the curing step S110, at a predetermined temperature for a predetermined period of time for sterilization thereof; and a cooling and aging step S130 of cooling and aging the first processed food sterilized by the heating step S120 to manufacture a complete product.

The curing step S110 is a step of preparing an auxiliary material to be mixed with any one of the raw materials except for fish, and putting the prepared auxiliary material together with the raw materials into the vacuum tumbler to allow the materials to be cured by mixing.

In one example, the auxiliary material may include chicken concentrate, barbecue seasoning, seaweed and additives, and the additives may include sugar, salt, white pepper, garlic powder, onion powder and ginger powder.

According to the present disclosure, the curing step S110 includes, when the raw material and the auxiliary material are mixed, putting 90 to 97% by weight of raw materials, and 1 to 4.5% by weight of chicken concentrate, 1 to 2.5% by weight of barbecue seasoning, 0.5 to 1.0% by weight of seaweed and 0.5 to 2.0% by weight of the additives into the vacuum tumbler for mixing.

In one example, the raw material used in the curing may be chicken breast, and only the one that is within 8 days from the date of manufacture is used.

In one example, by “within 8 days from the date of manufacture”, it means 8 days in a cold storage state after slaughtering chickens, and if it exceeds 8 days, there is a risk of deterioration of the raw materials due to the propagation of microorganisms. Accordingly, in the present disclosure, only the one that is within 8 days after slaughtering chickens is used.

In addition, the chicken concentrate may be a mixture of chicken extract from chicken meat, cyclodextrin, vegetable extract, and fruit extract in a predetermined weight ratio, and in the present disclosure, mixture of 94.56% by weight of chicken extract, 2.54% by weight of cyclodextrin, 1.52% by weight of vegetable extract containing onion, garlic, red pepper, and green onion and 1.38% by weight of fruit extract containing pear, grapefruit and apple is used.

In one example, cyclodextrin CD is a cyclic substance in which D-glucopyranose groups are circularly joined by α-1,4-glucosidic bonds, and there are α-CD (6 units), β-CD (7 units), γ-CD (8 units), and the like depending on the degree of polymerization of the constituent D-glucose. In the present disclosure, β-CD having molecular weight of 1,135 and water solubility (G/100 ml) of 18.5 is preferred, although not strictly limited thereto.

Meanwhile, when an amount of the individual raw materials mixed in the curing step S110 of the present disclosure is less than the above range, the overall flavor is weak, and in particular, when an amount of chicken concentrate exceeds the above range, the taste would not be harmonized, which therefore affects the overall sense of balance and appropriate realization of deep taste.

Meanwhile, since the additives are food materials commonly used for seasoning, detailed description thereof will be omitted. Nevertheless, while the ingredients to use and amounts of the same according to the purpose of cooking are known to some extent, it is not obvious to those skilled in the art to find the optimal mixing ratio and set the standard of taste.

In this curing step S110, when the raw material is meat or poultry, it is stored in cooling and freezing conditions, and when in freezing condition, the raw material is defrosted in a refrigerator within 48 hours before being put into the vacuum tumbler for curing. In one example, driving time of the vacuum tumbler (mixing time of raw materials and auxiliary materials) is set to 20 to 30 minutes, and mixing is performed while a vacuum degree is maintained at −0.08 to −0.1 cmHg. Through this process, the curing ingredient permeates into the center of the product to improve taste and flavor, and type and amount of the auxiliary material contained therein may vary depending on the product.

Further, in the curing step S110 of the present disclosure, when the first curing of mixing the raw material and the auxiliary material is finished, the second curing step of additionally adding polyphosphate to increase the water holding capacity and the binding force of the raw material and performing a second mixing may be further performed.

In one example, when performing the second curing step, the vacuum degree is maintained at −0.08 to −0.1 cmHg, and driving time of the vacuum tumbler is set to 20 to 30 minutes.

Further, for the meat/fish raw material other than chicken breast, such as beef and pork, it also can be cured together with auxiliary material with the same method described above, and for the raw material such as chicken ribs or chicken feet that is added with liquid seasoning, the first and second curing may also be performed.

The heating step S120 is a step of putting the first processed food cured at the curing step S110 into a hot chamber or an oven machine and heating the same for heat treatment. That is, it is a first step of heating the mixed and cured raw material before final sterilization.

The heating step S120 heats the first processed food under different heating conditions according to the type of raw materials so that sterilization can be performed.

For example, when the raw material is meat or poultry, the first processed food finished with the curing step S110 is heat-treated in a hot chamber. The heat treatment is performed at 70 to 90° C., preferably at 75 to 80° C. for 30 to 50 minutes, while being passed through the hot chamber.

Further, when the raw material is fish, heat treatment is performed at 180 to 250° C., preferably 215 to 230° C. for 3 to 10 minutes in the oven machine.

Through this heat treatment process, the moisture contained in the raw material is initially removed, thereby minimizing the discharge of dripping water which may occur during the sterilization to be performed in the storing and delivering step described below. In addition, according to the present disclosure, the heating step S120 is performed so as to cause the auxiliary materials to be permeated into the raw materials more efficiently.

Meanwhile, the first and second curing steps ensure the taste and smell of the auxiliary materials of the first processed food and the minimized discharge of drip water that may appear in the final sterilization. The discharge of drip water is a phenomenon that inevitably occurs in the heating process, but by minimizing the discharge of drip water, the possibility of microorganism generation can be lowered, and the risk of deterioration that may occur in long-term storage of the product can be minimized.

The cooling and aging step S130 is a step of cooling and aging the first processed food that underwent the heat treatment at the heating step S120, by first cooling it naturally and then aging it at a predetermined temperature.

The cooling and aging step S130 cools the heat-treated first processed food naturally at room temperature within 3 hours, and when the natural cooling is finished, ages the food by cold storage at a cold temperature for a predetermined period of time.

If the first processed foods are folded when they are cooled in natural cooling, there is a risk of microorganism propagation. Therefore, it is preferable that the foods are spread when cooled.

Further, for the aging by cold storage, storing and aging are performed within a temperature range of −2 to 5° C., and the foods are packaged in bulk packaging based on a unit of 7-8 kg or less in vinyl, in which the packaging is done with a semi-vacuum packaging method before cold storage.

In one example, by the “semi-vacuum packaging”, it means a form in which the inside of the package is filled with 80 to 95% of air. Accordingly, through this packaging method, drip water decreases and moisture content increases while the product is aged.

FIG. 2 is the sensory evaluation data of the decay degree according to a vacuum degree, from which it can be seen that product aging is possible without sensory change for up to 18 hours, when packaged in semi-vacuum packaging for 13 to 18 seconds. Accordingly, in the present disclosure, the semi-vacuum packaging is performed under 0.09±0.005 MPa for 13 to 18 seconds, and thereafter, aging is performed within a temperature range of −2 to 5° C., under the condition for aging by cold storage of the cured, processed food.

Afterwards, when the cooling and aging step S130 is finished, the storing and delivering step of inner packaging and outer packaging the aged processed food for delivery is performed.

The storing and delivering step includes a weighing step S140 of weighing the processed food by a predetermined weight, an inner packaging step S150 of inner packaging the weighed processed food, a sterilizing and cooling step S160 of sterilizing the inner packaged processed food, a metal detecting step S170 of detecting the presence or absence of metallic substances in the sterilized processed food, and an outer packaging step S180 of outer packaging the processed food.

The weighing step S140 is a preceding step to be performed so as to ensure that the processed food for inner packaging is inner packaged in the same weight, and accordingly, measures the processed food in which the drip water occurring from aging is minimized, so that inner packaging is performed per 100 g of the processed food.

The inner packaging step S150 is a step of inner packaging the processed food weighed by 100 g using a laminated transparent film.

The inner packaging step S150 is a step of putting the processed food into a laminated transparent film and sealing the opening with a vacuum packaging machine. In one example, the sealing conditions include a vacuum time of 14 to 20 seconds, a sealing adhesion time of 3 to 5 seconds, and a sealing temperature of 150 to 180° C.

Further, the vacuum degree should be 0.085 to 0.1 MPa, and foreign substances such as traces of raw materials or subsidiary materials should not be touched on the sealing part. In one example, if inner packaging is performed in a state that fails to meet the conditions described above, microorganism propagation can occur due to pinhole or insufficient vacuum sealing even after passing through the next process, i.e., the sterilization, in which case long-term preservation is unavailable.

The laminated transparent film is made by a general film lamination process, in which polypropylene film, nylon and CPR film are laminated.

The polypropylene film may herein be an OPP film (Oriented Polypropylene Film, biaxially oriented PP), and the laminated transparent film may be manufactured with a processed transparent film that is made by laminating a polypropylene film with a film such as nylon, CPR and the like.

This laminated transparent film is a special laminated film that can block light, air, and water, which are elements of microorganism propagation. Because light, air, and water are blocked, quality seldom changes during distribution at room temperature and storage for a long period of time. Meanwhile, the conventional canned foods, cans, or aluminum packaging method involve long hours of heating in the process, which causes damage to the product quality, and such film sheet has a problem in that it is not possible to see the inside of the product.

In particular, because the laminated transparent film of the present disclosure can replace the cans or canned foods, the processing time can be much saved and it is possible to check the inside of the product. Further, because the lamination is processed so as to endure high temperature of 180 to 200° C. and high pressure, shape of the film after the sterilizing is not changed.

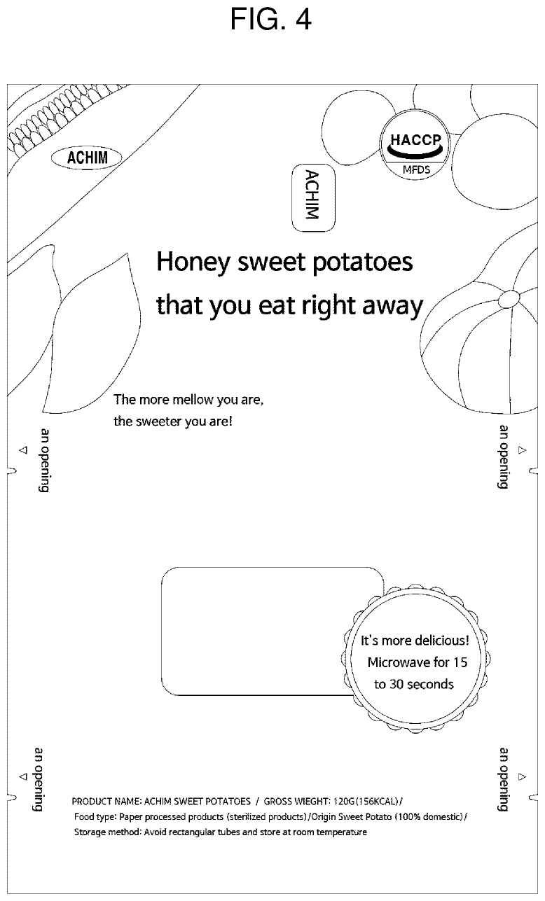

Further, as shown in FIG. 3, the laminated transparent film of the present disclosure may be formed so that one side of the laminated transparent film is transparent and the processed food is seen therethrough, or as shown in FIG. 4, it may be formed so that the entire surface is opaque. When one surface is formed to be transparent, the one entire surface may be transparent, or only a local position may be transparent.

The sterilizing and cooling step S160 is a step of heating the inner packaged product for sterilization thereof and then cooling the heated product, and it is a step of sterilizing and processing the unit-based item packaged food and livestock processed food at high temperature and high pressure.

The sterilizing and cooling step S160 performs the sequential steps of: sterilizing the processed food, which is inner packaged and vacuum sealed, at high temperature and high pressure; and cooling the sterilized processed food (product) at a predetermined temperature or lower.

The sterilizing step includes first to third sterilizing steps, with varying temperature and time for each step.

The first sterilizing step involves sterilization by heat treatment at a low temperature of 55 to 75° C., preferably at 60 to 65° C., for 30 to 40 minutes, the second sterilizing step involves sterilization by heat treatment at 90 to 110° C., preferably at 95 to 100° C., for 30 to 50 minutes, and finally, the third sterilizing step involves sterilization by heat treatment at 110 to 140° C., preferably 120 to 130° C., for 20 to 50 minutes.

In one example, the first sterilizing step and the second sterilizing step involve low temperature sterilization, in which sufficient coagulation of proteins occurs while cell destruction is kept minimized without changes in the feature and shape of the processed food (product).

Further, the third sterilizing is a step that enables the death of microorganisms through the high temperature and pressure process, which can allow room-temperature distribution, storage and long preservation through, so that commercial value of the product can be preserved without changes in the laminated transparent film.

Then the cooling step is performed, in which the cooling cools the product that passed all of the sterilizing steps at 40° C. or lower.

In one example, the time of cooling at 40° C. or lower varies by season, so it is preferable to set the time to 20 to 30 minutes in summer and 10 to 20 minutes in winter, but it is needless to say that the time may also vary depending on the raw material of the product.

The metal detecting step S170 detects whether or not a metallic component is included in the product after sterilizing and cooling is performed, and if a metallic component is included, processes the product as defective and discards the same, while allowing only the products that do not include a metallic component to be subjected to outer packaging.

The metal detecting step S170 is preferably performed through a general CCP-2P detection method, but not limited thereto.

The outer packaging step S180 is a step of outer packaging the product with general package paper, and the like, so that only the products that do not contain a metallic component are stored and delivered.

In this case, the outer packaging step S180 may further attach information providing sheets such as the type of product, the type of auxiliary material used in curing, precautions for storage, and the like, but not limited thereto.

It is to be understood that, unless specifically stated to the contrary, the term “comprise”, “include”, or “have” as used herein may mean that a corresponding component can be inherently included, and therefore, should be construed as meaning that other components may be additionally included rather than excluding the same, and all terms including technical or scientific terms have the same meaning as commonly understood by one of ordinary skill in the art to which this disclosure belongs, unless otherwise defined.

In addition, the present disclosure has been described in detail. However, it should be understood that the detailed description and specific examples, while indicating preferred embodiments of the disclosure, are given by way of illustration only, and various changes and modifications within the scope of the disclosure will become apparent to those skilled in the art from this detailed description. Accordingly, the embodiments disclosed in the present disclosure are provided to explain, and not to limit a technical art of the present disclosure, and thus, the scope of the present disclosure is not limited. The scope of the present disclosure should be construed by the following claims, and every technical idea within the equivalent scope of the following claims should be construed to be included in the scope of the right of the present disclosure.

1. A method for manufacturing a processed food, comprising steps of:
(a) putting, into a vacuum tumbler, 90 wt % to 97 wt % of a raw material including any one of meat or poultry that can be prepared as ham, ground processed meat, sausage, or fish that can be cooked as grilled shrimp or grilled eel, as an auxiliary material, 1 wt % to 4.5 wt % of chicken concentrate including 94.56 wt % of chicken extract, 2.54 wt % of β-CD with the characteristics of molecular weight of 1,135 and water solubility (G/100 ml) of 18.5, 1.52 wt % of a vegetable extract containing onion, garlic, red pepper, and green onion, and 1.38 wt % of a fruit extract containing pear, grapefruit and apple, and 1 wt % to 2.5 wt % of barbecue seasoning, 0.5 wt % to 1.0 wt % of seaweed, and 0.5 wt % to 2.0 wt % of additives, for a first curing while maintaining a vacuum degree of −0.08 to −0.1 cmHg for 20 to 30 minutes, and, when the first curing is finished, a second curing of adding polyphosphate to increase the water holding capacity and binding power of the raw material and mixing while maintaining the vacuum degree of −0.08 to −0.1 cmHg for 20 to 30 minutes;
(b) after the step (a), when the raw material is meat or poultry, heat-treating the cured processed food at a temperature of 70° C. to 90° C. in a heat chamber for 30 to 50 minutes, and when the raw material is fish, heat-treating the cured processed food in an oven machine at a temperature of 180° C. to 250° C. for 3 to 10 minutes;
(c) after the step (b), naturally cooling the processed food at room temperature, and when the natural cooling is finished, aging by cold storage;
(d) after the step (c), weighing the aged processed food by a predetermined weight, and inner packaging the weighed processed food with a laminated transparent film;
(e) after the step (d), sterilizing the processed food at a low temperature and at high a temperature and a high pressure, and cooling the sterilized processed food at a predetermined temperature or lower; and
(f) after the step (e), detecting presence or absence of a metallic substance in the sterilized and cooled processed food, and outer packaging only the processed food that does not contain a metallic component.

2. The method of claim 1, wherein the step (a) comprises, when the raw material has a characteristic of an agricultural product including grains, including vegetables, sweet potatoes, sweet pumpkin, and potatoes, an egg produced from poultry, and a fish including mackerel, Japanese Spanish mackerel, and Atka mackerel, washing the raw material, selecting the washed raw material according to its state, and removing a non-edible part of the selected raw material.

3. The method of claim 1, wherein, when the raw material is meat or poultry, the raw material is stored in cooling and freezing conditions, and when in freezing condition, the raw material is defrosted in a refrigerator within 48 hours before curing.

4. The method of claim 1, wherein the step (c) comprises bulk packaging in a vinyl based on a unit of 7-8 kg or less, wherein the packaging is performed with a semi-vacuum packaging method for 13 to 18 seconds at a pressure of 0.09±0.005 MPa, and then aging at a temperature of −2° C. to 5° C.

5. The method of claim 1, wherein the step (d) comprises sealing the laminated transparent film according to conditions including a vacuum time of 14 to 20 seconds, a sealing adhesion time of 3 to 5 seconds, a sealing temperature of 150° C. to 180° C., to achieve a vacuum degree of 0.085 to 0.1 MPa.

6. The method of claim 1, wherein the step (e) comprises first sterilizing the processed food at 55° C. to 75° C. for 30 to 40 minutes, second sterilizing at 90° C. to 110° C. for 30 to 50 minutes, third sterilizing by heating at 110° C. to 140° C. for 20 to 50 minutes, and after completing the third sterilizing, performing cooling at 40° C. or lower.

7. The method of claim 1, wherein the laminated transparent film comprises a polypropylene film, nylon and CPR laminated together.

8. The method of claim 1, wherein the laminated transparent film is formed so that one side is transparent to allow the processed food to be seen therethrough, or the entire surface is formed to be opaque.
